(19) United States
(12) Patent Application Publication
(10) Pub. No.: US 2013/0290534 A1
(43) Pub. Date: Oct. 31, 2013

(54) Method for Setting Network Device with Wireless Area Network and Controller, Network Device and Communication Platform

(71) Applicant: ZEON CORPORATION, Taipei City (TW)

(72) Inventor: Tien Chun Tung, Taipei City (TW)

(73) Assignee: Zeon Corporation, Taipei City (TW)

(21) Appl. No.: 13/868,118

(22) Filed: Apr. 23, 2013

(30) Foreign Application Priority Data
Apr. 27, 2012 (CN) 201210128756.5

(51) Int. Cl. H04L 12/70

(52) U.S. Cl. CPC H04L 47/70
USPC 709/225

(57) ABSTRACT

A method for setting a network device with a wireless area network and a controller, a login Account ID/password is entered through the controller with an user interface to login a communication platform; said controller searches for a SSID of the network device with a predetermined naming through a wireless area network function; the controller connects with the network device that is found in said wireless area network and sets parameter(s) for said network device; said network device connects to the internet with internet link information in said parameter(s) and logs in to the communication platform with the login Account ID/password in the parameter(s), and if said communication platform confirms that an identifier of said network device has been authorized, then said network device is allowed to login successfully and setting work is completed.

### CROSS-REFERENCE TO RELATED APPLICATIONS

This application claims the priority of China Patent Application No. 201210128756.5 filed on Apr. 27, 2012, in the State Intellectual Property Office of the P.R.C., the disclosure of which is incorporated herein by reference.

### BACKGROUND OF THE INVENTION

1. Field of the Invention

The invention relates a network device setting method, especially relates to a method for setting the network device with a wireless area network and a controller, a network device and a communication platform.

2. Descriptions of the Related Art

Conventionally, when a network device without user interface, such as router, network printer and network camera, is under setting or control, user has to use another controller with user interface, such as computer and/or smart phone, to enter a predefined IP address of the device desired to be set or controlled. The user has to enter other information such as IP address, port number, login Account ID and login password etc., via the user interface of the controller. The network device can then be connected and logged in to the communication platform (servers) and becomes accessible to the controller or other devices. If the network device is in the area network behind a router, the user may also need to further configure the router such that the router allows the network connection between the network device and the controller. Therefore to setup a network device, basic knowledge of networking concept and terminology are required, moreover, the complex procedure involved in setting up aforementioned network device is usually too difficult to general users.

For example, a building management company needs to install multiple network cameras on the doors, elevator rooms, and stairway of some important floors, and the recorded contents of the cameras are delivered to a specific video & audio storage device, for the specific video & audio storage device to store the contents of the network cameras. However, before the contents recorded by the remote network cameras can be stored in the video & audio storage device, the aforementioned complex configuration for the connecting of the devices to the Internet, and the communication platform login procedures are all necessary to be done on each and every network devices. Moreover, respective login Account IDs/passwords have to be applied for different network cameras, and that still results in inconvenience and is the problem necessary to be figured out by those skilled in the art.

### SUMMARY OF THE INVENTION

In view of the conventional technical problems mentioned above, one of the purposes of the invention is to provide a method for setting network device with wireless area network and controller, the network device and communication platform to simplify the networking setting procedure for the network device.

According to another purpose of the invention, a method for setting the network device with the wireless area network, and the controller, the network device and the communication platform are provided for finding out rapidly and controlling the network device desired to be controlled in the internet.

According to a further purpose of the invention, a method for setting the network device with the wireless area network, and the controller, the network device and the communication platform are provided for managing multiple network devices with a single login Account ID/password.

To achieve the above purposes, the invention provides a method for setting the network device with the wireless area network to login the network device to the communication platform and setting the network device as service unit of the communication platform, including the following steps: entering login Account ID/password through the controller with user interface to login the communication platform; then, the controller searches the SSID of the network device with predetermined name through wireless area network function; the controller links with the network device found in the wireless area network and sets parameters for the network device; the network device connects to the internet with the internet link information in the parameters and logs in to the communication platform with the login Account ID/password in the parameters; and the communication platform allows the network device to login and complete setting works if the communication platform confirms that the identifier of the network device is authorized, otherwise the network device is prohibited from the login to the communication platform.

The invention further provides a network device to be configured as the service unit in the communication platform through the wireless area network function, including: wireless function module, which opens the wireless function and announces the SSID which utilizes the identifier as the predetermined naming method, for an external controller to find and access the SSID and wirelessly connect with the network device; and network connection module, which receives parameters delivered from the external controller and connects to the communication platform with the internet link information in the parameters, and logs in to the communication platform with the Account ID/password in the parameters to become a service unit of the communication platform.

Moreover, the aforementioned network device further includes a management module, which manage the access authority between the controller and itself, such that the controller becomes the administrator of the network device if the controller has the same login Account ID/password as the network device.

The invention further provides a controller, which configures the network device as a service unit of the communication platform through wireless area network function, including: an user interface, which is used to enter the login Account ID/password to login the communication platform and is a control application program with corresponding APP ID (Application Identifier); a network connection module, which is used to login to the communication platform with the login Account ID/password entered through the user interface and provide the APP ID of the control application program to the communication platform for the communication platform to record the identification information containing the login Account ID and the APP ID; and a wireless function module, which opens wireless function to search the SSID of the network device with the identifier as predetermined SSID naming method; and deliver the parameters entered by the user interface to the network device after the network device with the corresponding SSID is found and connected; then the network device uses such information in the parameters to connect to the internet and login to the communication platform such that the network device becomes a service unit of the communication platform.

The invention further provides a communication platform for the controller to control the network device, including: a login module, which records and manages the login Account ID/password of the controller and the network device and records the identifier of the authorized network device, so that after the identifier of the network device has been confirmed as authorized, the login module allows the network device to login with the Account ID/password provided by the controller for the network device to become the service unit; a search module, which searches the connection method of the network device which uses the same login Account ID to login according to the search request from the controller, and provides the connection method which is found to the controller for the controller to connect with the network device by using the connection method.

In the aforementioned communication platform of the invention, the network device has a built-in application with an APP ID (application ID) and the login module records the APP ID of the network device, such that after the network device becomes the service unit, the login module records identification information containing the login “Account ID”, “APP ID” and the IP connection method for the network device. Besides, the login module may receive the “APP Resource” (application resource) provided by the network device, while the “APP Resource” of the network device is given by user with the controller, so that after the network device becomes the service unit, the login module records identification information containing the login “Account ID”, “APP ID”, “APP Resource”, and the IP connection method for the said network device. Moreover, the controller has a built-in control application with an APP ID, and the login module records the APP ID of the controller such that the communication platform may record the identification information containing the login “Account ID” and the “APP ID” for the controller that has logged in. Because all APPs that are allowed to login the communication platform know their own APP IDs, and also know the APP IDs of other applications that they are intended to cooperate with, the purpose to separately manage multiple network devices with a single login Account ID is achievable by using the same login “Account ID” for all the cooperating network devices and the controller, while they use different “APP IDs” and/or “APP Resources” to login, and therefore can be easily managed with a single login Account ID.

With respect to the method for setting network device with wireless area network and the controller, the network device and the communication platform of the invention mentioned above, the aforementioned wireless area network function is the wireless area network function based on IEEE 802.11 standard, and the network device is the device which supports IEEE 802.11 standard. Additionally, the aforementioned identifier may be a hardware identifier or a product serial number.

Moreover, with respect to the method for setting network device with wireless area network and the controller, the network device and the communication platform of the invention mentioned above, after the network device logs in to the communication platform and completes the configuration procedure, the controller logs in to the communication platform with the login Account ID/password of the network device; and the communication platform provides the connection information of the network device with said login Account ID to the controller, according to the request from the controller.

Besides, the controller sets different APP Resources for multiple network devices that use the same login Account ID to achieve the purpose of managing multiple network devices with a single Account ID. Further, after the controller requests and then the communication platform provides the connection information of the network devices that have the same login Account ID as the controller, the controller connects to the network devices to become the administrator and can sets the Account IDs having access authority of the network device.

Therefore, the method for setting the network device with the wireless area network, and the controller, the network device and the communication platform of the invention allow the administrator who performs the network setting through the controller does not need to remember the complex networking setting procedure, but only needs to enter the necessary parameters to connect the network device to the internet through the user interface of the controller. The controller provides automatically the login Account ID/password used by the controller to the network device, such that the network device may login directly to the communication platform with the same login Account ID/password used by the controller, subsequently the communication platform verifies the hardware identifier of the network device itself. The login is allowed if the verification confirms; the success of the setting such that it is convenient for the controller to find the network device on the communication platform for subsequent management or control. Hence, the networking setting for the network device is simplified.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view of the network architecture utilizing the method for setting the network device with the wireless area network according to the invention;

FIG. 2 is a procedure flow chart of the method for setting the network device with the wireless area network according to the invention; and

FIG. 3 is a block diagram of the basic architecture with the network device, the controller and the communication platform implementing the method for setting the network device with the wireless area network according to the invention.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

The invention provides a method for setting a network device with a wireless area network by using a controller to set the network device rapidly and conveniently through the wireless area network for it to login to a communication platform and become a unit on the communication platform to implement application functions, for example application services such as remote video monitor or alarm notice etc., required by an user. Besides, to manage various network devices logged in to the communication platform effectively and securely, the communication platform may record identifiers of multiple legally authorized network devices for the communication platform to verify the logged in network device about whether the network device has been authorized or not. The aforementioned identifier may be the hardware identifier or the product serial number. All identifiers which can identify the uniqueness of the network device are suitable. Commonly speaking, before the commercial behavior for the network device such as delivery or sales, the executor of the commercial behavior provides the identifier of the network device to the administrator of the communication platform for the administrator to record the identifier of the network device on the communication platform, and uses the identifier to check the legality of the network device, such that it prohibits from unauthorized network devices to login the communication platform at will effectively.

Moreover, because there are various kinds of units served or set by the communication platform, to ease the identification and management, the communication platform further records the APP IDs of all legal units. The so called “APP ID” indicates the Application Identifier (Application ID, or APP ID) assigned by the administrator of the communication platform in advance for the APP (application, or application program) executed by each legal unit logged in to and operated on the communication platform. Therefore, all legal APPs know their own APP Identifiers and also know the APP Identifiers of other APPs to be communicated or cooperated with. For example, the APP ID of the network camera (that is, the APP Identifier of the network camera) is assigned 100, while the APP ID of the controller that manages the network camera is assigned 200. With the login Account ID of an unit used to login the communication platform and the APP ID of that unit, it is convenient for different units that login to the communication platform to search with each other. For example, a network device an user desires to manage is a specific network camera, that user uses his/her login Account ID “B” to login the communication platform by using the controller (with APP ID 200), then the user enters the login Account ID “A” of the network camera desired to be controlled by the controller, the APP 200 executed on the controller searches the unit with “login Account ID A and APP ID 100” on the communication platform, such that the network camera logged in with login Account ID “A” and APP ID “100” on the communication platform may be found for the controller to acquire the IP connection method of the network camera and connect to the network camera on the communication platform and thus control the network camera. Thereby, different network devices are classified by different APP IDs (that is, APP Identifiers). Hence, as for the communication platform, each logged in network device records at least the login Account ID and the APP ID of that network device. Additionally, the object to be searched by the APP ID 200 is set to APP ID 100 in advance in the program content of the APP (with APP ID 200) of the aforementioned controller, and it may be declared in advance that only the service request issued by the APP ID 200 will be accepted in the program content of the APP of the network camera. Shortly speaking, the APP ID of the APP operated by each unit is assigned by the administrator of the communication platform in advance such that different or the same APPs of different units may search the mutual IP connection methods and interact with each other by the login Account IDs and the APP IDs of the login units through the communication platform.

Besides, for the usage convenience and management requirement of the network device, the communication platform may further record the APP Resource of the network device for the units logged in with the same Account ID and APP ID may use different APP Resources for further classification. The identification information recorded in the communication platform for each network device will be explained in detail later. Here, we will describe how each network device is set as an unit on the communication platform.

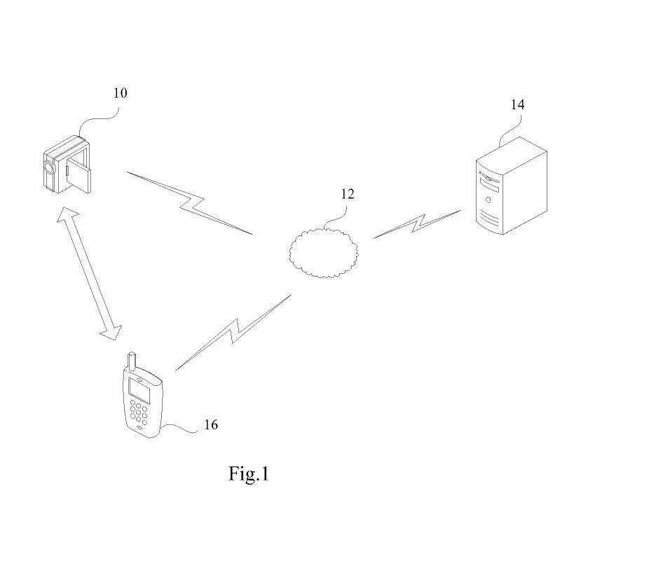

First, refer to FIG. 1, which shows the schematic view of the network architecture of the method for setting the network device with the wireless area network according to the invention. As shown in FIG. 1, the aforementioned network device may be a network camera 10. Because there is no network setting information in the network camera 10 when the network camera 10 is delivered from the factory, the network camera 10 cannot be connected to the internet 12 in a common situation. The networking setting may be performed for the network camera 10 through the controller with user interface such as smart phone 16 or computer. To simplify the setting procedure, the invention creates a wireless network link between the network camera 10 and the smart phone 16 with a wireless area network function in advance. The wireless area network function is, for example, the Wi-Fi technique based on IEEE 802.11 standard. In other words, the network camera may be a Wi-Fi device. Thereby, the smart phone 16 finds out the network camera 10 rapidly through the wireless function and sets parameters such as networking information and login information for the network camera 10. Subsequently, the network camera 10 connects to the communication platform 14 according to the networking information and logs in to the communication platform 14 with the login information, and the communication platform 14 may verify the hardware identifier of the network camera 10 to be logged in. Once the verification is passed, the setting work for the network device is completed, that provides the user a method for setting the network device securely, conveniently and rapidly.

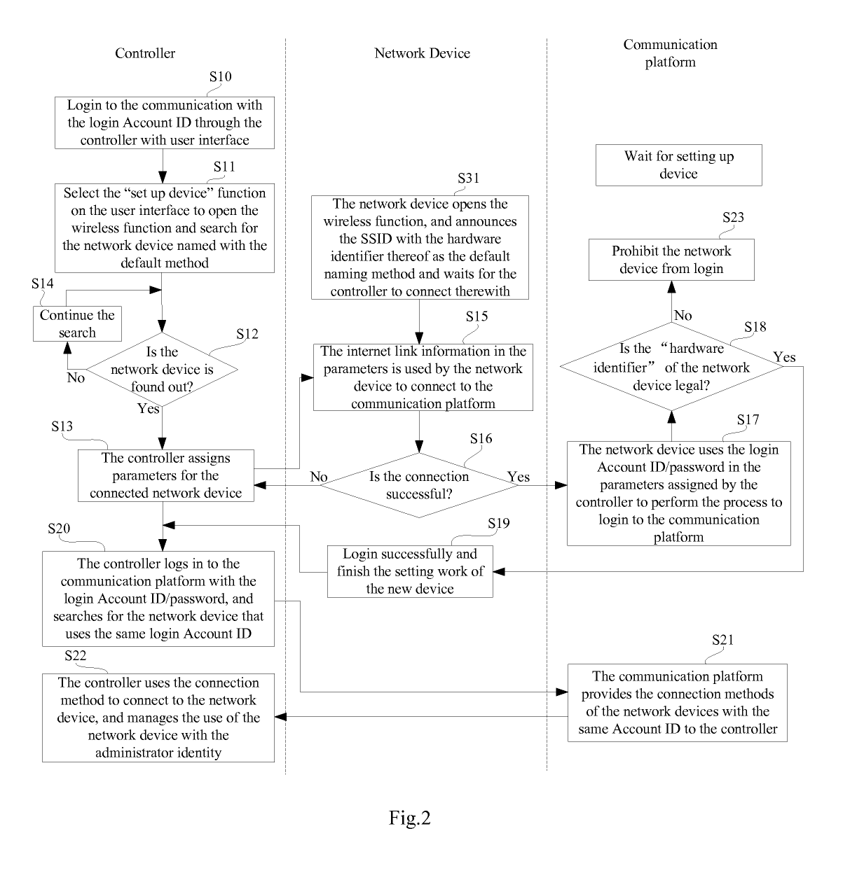

Refer to FIG. 2, it shows a flow chart of the method for setting the network device with the wireless area network according to the invention. The method of the invention for setting the network device with the wireless area network sets the network device incapable of connecting to the internet through the controller that has an user interface and has logged in to the communication platform, such that the network device may be logged in to the communication rapidly and set as a service unit in the communication platform. What needs to be stated is that the controller has already applied for login Account ID and password in the communication platform, and the communication platform may record the identifier of the network device. The network device is managed securely with the identifier and the network device is further confirmed to see whether the authorization is available, so that the connection method of the network service unit logged in successfully may be acquired through the communication platform with successful connection. The identifier may be a hardware identifier or a product serial number, and the example adopts the hardware identifier as exemplary description.

Then, as shown in FIG. 2, for the controller, step S10 is performed at first, the user logs in to the communication platform with the login Account ID and password through the controller with user interface. The so called user interface here indicates the user input interface supported by the APP (with legal Application ID assigned by the communication platform) operated on the controller, and the user interface is used as the communication interface between the controller and the communication platform and the network device. Subsequently, step S11 is performed. Additionally, as what stated previously, because the controller logged in to the communication platform installs and executes the user interface of the APP, as for the communication platform, the login Account ID of the controller and the APP ID of the controller are used to create the identification information of the controller.

In step S11, the user selects the “set up device” function on the user interface to open the wireless function and search for the wireless SSID (Service Set Identifier) of the network device named with the default method, and then step S12 is proceeded. Additionally, there are many SSID default naming methods, which generally consist of the APP ID and the hardware identifier of the network device (but not limited thereto). Take “gcam_{—}2D3415A97B92” as an example, “gcam” indicates the APP ID of the network device and “2D3415A97B92” is the MAC address of the network card of the network device. The user knows it is a network camera (cam) once “gcam” is seen. The MAC address is generally printed on the case of the network device or printed on the appended user operation manual document for the user to recognize which network device is to be set when the user needs to set the network device and there are multiple network devices configured at the same time. Besides, as what mentioned above, the user interface is an APP, which controls the network device, with functions such as changing the attribution of the network device, managing and operating the network device etc. provided, wherein only the function of setting up new device is stated as an example. In other words, both maintenance and management of the network device may be implemented by executing the user interface with the controller.

In step S12, it determines whether the controller which opens the wireless function has found the network device, if yes, then step S13 is proceeded wherein the controller assigns parameters for the connected network device, the parameters include: the necessary setting data for the network device to connect to the internet, the login Account ID/password of the login communication platform, time zone message and the aforementioned APP Resource (as will be stated later), and the aforementioned login Account ID/password of the controller are delivered automatically to the network device to be logged in to the communication platform, and then step S15 is proceeded; conversely, if the controller has not found the network device, then step S14 is proceeded to continue the search.

Additionally, before the controller connects to the network device for the aforementioned parameters assigned thereto, step S31 as shown in FIG. 2 is proceeded additionally by the network device, wherein the network device opens the wireless function, and announces the SSID with the hardware identifier thereof as the default naming method for the controller to search and waits for the controller to connect therewith. The aforementioned function of opening the wireless function is based on, for example, the Wi-Fi technique of IEEE 802.11 standard. Generally speaking, as the network device is initiated to be turned on at the first time, the network device cannot connect to the internet because there is no any setting parameter assigned, such as the internet networking parameters or other control parameters of the device etc. At that time, the network device enters automatically the state of “waiting for the wireless connection of the controller to perform setting”. Alternatively, the user of the controller opens the wireless setting function of the network device by himself/herself with, for example, the reset functional key of the network device pressed, for the network device to enter the state of “waiting for the wireless connection of the controller to perform setting”.

In step S15, after the network device receives the parameters delivered from the controller through the wireless function, the internet link information in the parameters is used to connect to the communication platform, and then step S16 is proceeded.

In step S16, it determines whether the network device is connected to the communication platform or not, step S17 is proceeded if the network device connects to the communication platform; it returns to step S13 if the network device does not connect to the communication platform such that the controller continues to assign the parameters to the network device for connecting to the internet.

In step S17, after the communication platform receives the connection request from the network device, the request that the network device desires to use the login Account ID/password in the parameters assigned by the controller to perform login process is received. Because the controller has logged in the communication platform successfully through the login Account ID/password, the login Account ID/password assigned by the controller is available normally for login. Therefore, the communication platform allows the network device to login, and then step S18 is proceeded.

As for step S18 about the determination of the legality of the hardware identifier of the network device, what mentioned in advance is that, the hardware identifier of the network device is provided to the communication platform by the APP on the network device. If the APP of the network device does not provide the hardware identifier, the communication platform will not perform the determination about whether the hardware identifier of the network device is legal or no, for example, the APP of the controller will not provide the identifier. Hence, the communication platform determines whether the controller is legally authorized, in other words, dependent on the APP ID. However, the major purpose to determine whether the hardware identifier of the network device is legally authorized or not is to control and mange effectively various network devices that login the communication platform to prevent from unauthorized network device uses illegally the services provided by the communication platform.

In the example, in step S18, the network device provides its hardware identifier for the communication platform to determine whether the hardware identifier of the network device is legal or not, step S19 is proceeded if determined as legal; conversely, step S23 is proceeded if determined as illegal to prohibit the network device from login. As mentioned above, the hardware identifier is used for the communication platform to confirm whether the network device has been authorized. Generally speaking, it is the network device supplier to provide the identifier such as the hardware identifier of the network device or the serial number of the product to the administrator of the communication platform, and record in the communication platform for the communication platform to allow the legally authorized network device to provide services through the internet, and thereby the network security of the communication platform is achieved.

In step S19, after the network device passes the confirmation of the login legality and the security legality of the communication platform, that is the network device logs in the communication platform successfully, and the “login Account ID”, “APP ID” and/or “APP Resource”, and “IP connection method” of the network device are announced on the communication platform, the setting work for the new device is completed. Meanwhile, the controller may login to the communication platform, and search for successfully logged in network devices on the communication platform, that is, search for the IP connection method of the network device to connect and to control it according to the “login Account ID”, “APP ID” and/or “APP Resource” of the network device. Additionally, as mentioned above, the communication platform has already recorded the APP IDs (that is APP Identifiers) of the network devices that login with Account IDs and passwords, respectively. Therefore, as for the communication platform, it records the identification information of the logged in network device with the login Account ID of the network device and the APP ID and/or APP Resource of the network device and its IP connection method, for the logged in controller to search the IP connection method of the network device to be searched according to the identification information of the network device.

In step S20, the controller logs in to the communication platform with its login Account ID/password, and searches for the network device that logs in the communication platform with the same login Account ID, subsequently step S21 is proceeded. Besides, when the controller that logs in to the communication platform searches for the network device according to the login Account ID of the network device entered by the user on the controller, the controller may decides by itself to search the network devices of different APP IDs. For example, if the controller may control various different network devices, the controller will search for various APP IDs of different network devices supported by the controller automatically. For example, the network devices of various different APP IDs such as network cameras, network printers or network bells owned by the login Account A. That is, a controller may be used to control one or various different network devices.

In step S21, the communication platform provides the connection methods of the network devices with the same Account ID to the controller, step S22 is subsequently proceeded.

In step S22, the controller uses the connection method provided by the communication platform to connect to the network device, and manages the use of the network device with the administrator identity.

Additionally, after the network device logs in to the communication platform successfully, the notification service may be provided additionally to the controller according to the function of the network device. For example, if the network device has the AP (Access Point) mode, it may notify the controller with a message about successful login after the network device logs in to the communication platform successfully for the controller to re-login the communication platform after receiving the message to perform the network device management work from the step S20 to the step S22 mentioned above. For another situation, if the network device does not have the notification function, the controller cannot know whether the network device has logged in to the communication platform successfully. However, the controller may determine the result according to the SSID connection status of the network device. In detail, as the controller recognizes that its SSID connection status with respect to the network device becomes interrupted, that indicates that the network device has connected to the communication platform through the internet, at that time, the controller may re-login to the communication platform to execute the network device management work as mentioned in the step S20 to the step S22 above.

From the method for setting the network device with the wireless area network according to the invention as mentioned above, we know that in the process that the controller sets the network device to connect to the communication platform, the method sets automatically the login Account ID/password used by the network device to login to the communication platform to be the same as the login Account ID/password of the controller, and thus the existent complex setting procedure is simplified. Besides, in step S13 that the controller assigns parameters to the connected network device, the controller may further set APP Resource for the network device. For example, if the network devices the user desires to set are multiple network cameras, which are to be installed on the community building door, elevator rooms, and staircases on some important floors, the user may assign and use the same login Account ID/password for those network cameras through the controller and set different APP Resources, respectively, such as the APP Resource of a certain network camera may be set as door, and that of a certain network camera may be set as staircase. Therefore, the controller may use a single login Account ID to control or monitor multiple network devices, and select the network device desired to be controlled according to the respective APP Resource, such that the controller uses that login Account ID becomes the administrator of the network device using the same login Account ID. Therefore, the communication platform records the identification information of the network device with the login Account ID, the APP ID of the network device, the APP Resource of the network device and the IP connection method of the network device.

To clarify the function of the aforementioned identification information, a further example is described as below. Three network cameras have logged in the communication platform and have been set as units on the communication platform. The login Account IDs of the three network cameras are all “A” and the APP IDs thereof are all “100”. The APP Resources of the three network cameras may be preset to “door”, “living room” and “kitchen” by a network device administrator when the three network devices login to the communication platform, respectively. Subsequently, an user may login to the communication platform to search for the network camera desired to be controlled through the control which has camera control APP installed and executed, that is, the user enters the message of login Account ID “A” through the camera control APP such that the controller finds out three network cameras that use the login Account ID “A” to login on the communication platform, and respectively, their identification information is (1) “(login Account ID) A/(APP ID) 100/(APP Resource) door/(IP connection method) X”, (2) “(login Account ID A/(APP ID) 100/(APP Resource) living room/(IP connection method) Y”; and (3) “(login Account ID) A/(APP ID) 100/(APP Resource) kitchen/(IP connection method) Z”. Additionally, the controller (APP) has already set 100 as the APP ID to be searched for in the program such that as for the user on the controller side, the only search condition entered is the login Account ID of the network device; and all network devices that meet the search condition can be found automatically.

Besides, after the controller logs in the communication platform with the login Account ID to have the administration authority on all the network devices which using the same login Account ID, the controller can set additional Account IDs to have access authority of said network devices. For example, the Account IDs with access authority are listed as a white list, such that the number of users who may use the network device may be changed in correspondence to the requirement of control or monitor. For example, as for a family, grandfather, grandmother, father and mother may login the communication platform at the same or different time through their own smart phones and login Account IDs, respectively, to watch the same network camera, wherein, if the login Account ID used by the father is set as the login Account ID with administration authority, the login Account ID of the network camera is the same as the Account ID used by the father, therefore, the father may further set the login Account IDs that may use the network camera, for example, to allow the grandfather, the grandmother and the mother to watch the network camera, too; conversely, the Account ID that is not allowable to access the network device may also be set, for example, an Account ID with no access authority is listed as a black list.

Moreover, for a variant example of the method for setting the network device with the wireless area network according to the invention, if the authorization issue of hardware devices is not under consideration, the determination of the legality of the hardware identifier may be omitted, that is the step S18 shown in FIG. 2 may be omitted, and only the legality of the login Account ID/password is determined. By the way, as for whether the communication platform has to determine the legality of the hardware identifier of the controller or network device, the built-in APP of the controller or network device may decide whether its hardware will be uploaded or not. In a general situation, the APP of the controller is set as unnecessary to upload the hardware identifier because a hardware device may become the controller of the invention without limitation as long as the hardware device has the APP installed and executed.

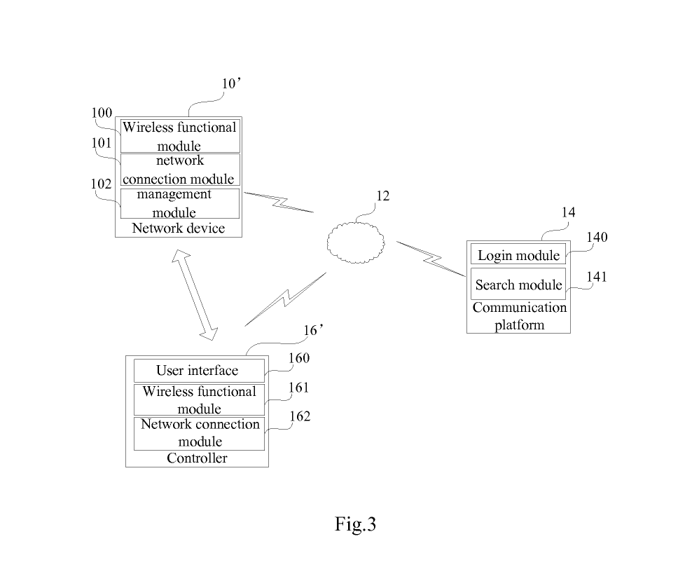

To implement the method for setting the network device with the wireless area network as shown in FIG. 2, the invention further provides a network device, a controller and a communication platform, as shown in FIG. 3, to show the block diagram of the basic architecture of the network device, the controller and the communication platform that implement the method for setting the network device with the wireless area network according to the invention. The network device 10′ may include a wireless functional module 100, a network connection module 101 and a management module 102. The controller 16′ includes at least an user interface 160, a wireless functional module 161 and a network connection module 162. The communication platform 14 includes a login module 140 and a search module 141. Additionally, to simplify the drawing and description, only functional modules related to the major characteristics of the invention will be described below, the descriptions for other functional modules, for example, power module, key module or display module will be omitted.

The wireless functional module 100 of the network device 10′ is used to open the wireless function to announce the SSID using the APP ID and identifier (but not limited thereto, all the data that may be used to identify the network device is suitable) as the preset naming method for the wireless functional module 161 of the controller 16′ to search for the SSID with wireless method and perform connection according to the network device 10′ that has the SSID found.

Before the wireless connection between the controller 16′ and the network device 10′, the controller 16′ enters the login Account ID/password through the user interface 160 of the controller 16′ to login the communication platform 14, and the network connection module 162 of the controller 16′ logs in to the communication platform 14 according to the login Account ID/password entered by the user interface 160, for the login module 140 of the communication platform 14 to determine the legality of the login Account ID/password of the controller 16′, such that the setting work for the network device described below is allowable. What necessary to say is that the user interface 160 is an APP (application or application program). The APP ID (that is, APP Identifier) of the APP has been recorded in the communication platform 14. The network connection module 162 not only provides the aforementioned login Account ID/password to the communication platform, but also provides the APP ID to the communication platform 14, for the login module 140 of the communication platform 14 to record the identification information containing the login Account ID and the APP ID. When the wireless functional module 161 of the controller 16′ finds the network device named with the preset method in the SSID announced on the wireless network, it delivers the parameters entered through the user interface 160 to the network device 10′ for the network connection module 101 of the network device 10′ to connect to the internet and the communication platform 14 with the internet connection method in the parameters, and utilizes its identifier and the login Account ID/password in the parameters to login to the communication platform 14 successfully and becomes a service unit of the communication platform 14. Additionally, the network device 10′ has built-in APP, and the login module 140 further records the APP ID (APP Identifier) of the network device APP, such that the communication platform will record the identification information about the login Account ID, the APP ID and the IP connection method of the network device 10′ after the network device 10′ becomes the service unit. As stated above, the communication platform may also record the identification information about the login Account ID, the APP ID, the APP Resource and the IP connection method according to different application requirements.

Besides, to make any hardware unit that logs in to the communication platform 14 be the hardware unit that meets the authorization qualification to enhance the network security of the communication platform, the authorized identifiers of network devices have been recorded in the login module 140 in advance, such that a network device is allowed to login successfully only after the identifier of that network device has been authorized. The aforementioned identifier may be a hardware identifier or a product serial number, and any identifier that is capable of recognizing the uniqueness of the network device and controller is suitable.

After the network device 10′ becomes the service unit of the communication platform 14, the search module 141 of the communication platform 14 searches the connection method of the network device 10′ using the same login Account ID to login according to the login Account ID/password entered by the controller 16′ having administrator identity, and provides the IP connection method that is found to the controller 16′, for the controller 16′ to connect with the network device 10′ desired to be controlled according to the IP connection method and controls the network device 10′.

From the method for the controller 16′ and the network device 10′ to login to the communication platform 14, the controller 16′ manages multiple network devices 10′ with one login Account ID/password, such that the management module 102 of the network device 10′ sets the controller 16′ using the same login Account ID/password to login as the administrator. Besides, to ease management and identification, the management module 102 may further provide the controller 16′ that belongs to the administrator identity to set the APP Resource for the controlled network device 10′ used to login to the communication platform. Therefore the controller 16′ that uses the same login Account ID/password to login can perform management tasks on multiple network devices according to different APP Resources of each of the network devices 10′, such that the purpose of using a single login Account ID to manage multiple network devices using the same login Account ID is achieved. What needs to be explained is that, under the situation that the controller “sets network device with wireless area network”, the controller is regarded as the administrator of the network device, such that besides the automatic setting for login Account ID/password, the APP Resource of the network device may also be set on the user interface of the controller.

From what mentioned above, for the method for setting network device with wireless area network according to the invention, the controller performs necessary parameter setting about internet connection and communication platform login with wireless area network function for the network device in advance. This method is comparatively convenient in comparison to the existent setting methods. Additionally, as the network device desired to be set can connect to the internet by itself and login to the communication platform with its login Account ID/password and the identifier such as a hardware identifier or a product serial number, then the controller may perform control setting and subsequent management for the network device only by searching for the connection method of the network device according to the login Account ID of the network device through the communication platform. The setting method is also very convenient.

Besides, the invention supports that one controller uses one login Account ID to manage or use multiple network devices with the same or different APP IDs. These kinds of works are simplified significantly to improve the usage efficiency and satisfy the requirement of users.

In summary, with respect to the method for setting network device with wireless area network and controller, network device and communication platform, the controller has built-in control application with an APP ID, the communication platform records the APP ID of the control application, the network device also has built-in device application with an APP ID, the communication platform also records the APP ID of the device application, the communication platform not only allows the controller and network device to login according to login Account ID/password but also allows the controller and network device to login according to the recorded APP ID, the “login Account ID, APP ID, and/or APP Resource, and IP connection method” of the controller and the network device are recorded on the communication platform, and the controller and the network device that logged into the communication platform acquires APPs that may communicate and operate therewith through respective APP IDs. Therefore, the major work of the communication platform is to verify the login Account ID/password and the APP ID for the controller and the network device desired to login, (besides, the administrator may set APP Resource for a network device to differentiate between different network devices with the same Account ID and APP ID), such that the controller or the network device is allowed or rejected to login to the communication platform. Then, the network device that is allowed to login may announce its own IP connection method actively (it could also selects not to announce the connection method, but that will cause it not to be found by other units), that is, the communication platform not only records the login Account ID and the APP ID (or including APP Resource) of the network device, but also records the IP connection method, such that the controller that logs in to the communication platform can find one or more network devices having different APP Resources that login with the same login Account ID and APP ID, and acquires the connection methods of those network devices. Besides, the architecture of the invention also allows a controller to find one or more network devices having different APP IDs that login with the same login Account ID. Therefore, the method for setting network device with wireless area network according to the invention not only completes the setting of the network device rapidly and easily, but also further implements the point to point communication between the controller and the network device.

While the present invention has been shown and described in connection with the embodiments, it will be apparent to those skilled in the art that modifications and variations can be made without departing from the spirit and scope of the invention as defined by the appended claims.

1. A method for setting a network device with a wireless area network to login said network device to a communication platform and set said network device as a service unit of said communication platform, including the following steps:
a controller enters a login Account ID/password to login said communication platform;
said controller searches for a SSID of said network device, said SSID is named with a predetermined rule;
said controller connects with said network device found in said wireless area network and sets parameter(s) for said network device;
said network device connects to said communication platform with internet link information in said parameter(s);
said network device login to said communication platform with the login Account/password in said parameter(s); and
if said communication platform confirms the login Account ID/password in said parameter(s), then said network device is allowed to login successfully and complete the setup of the network device, otherwise said network device is prohibited from login.

2. The method for setting the network device with the wireless area network as claim 1, wherein said communication platform confirms an identifier of said network device for the connected network device, such that said identifier is confirmed to be whether legal or not, if said identifier is confirmed to be legal, then said network device is allowed to login successfully, otherwise said network device is prohibited from login.

3. The method for setting the network device with the wireless area network as claim 2, wherein said network device has a message report function to report the result about the login of said network device or the connection to said communication platform back to the controller, such that when said communication platform confirms that the identifier of the connected network device is illegal to prohibit said network device from login, said network device will report the message with respect to that the identifier is illegal to the controller.

4. The method for setting the network device with the wireless area network as claim 1, wherein said network device announces a WiFi SSID using the hardware identifier of said network device as a predetermined naming rule through said wireless area network for the controller to search.

5. The method for setting the network device with the wireless area network as claim 1, wherein said network device has a built-in device application with an APP ID, and said communication platform records the APP ID of said network device, after said network device logs in said communication platform and completes setting step, said communication platform records the device identification information, including login Account ID, APP ID and IP connection method, for said network device, and further executes the following steps:
said controller logs in said communication platform with the login Account ID/password of said network device and then search for said network device; and
said communication platform provides the IP connection method of said network device to the controller, and then the controller connects to the network device.

6. The method for setting the network device with the wireless area network as claim 5, wherein after said controller connects with said network device according to the IP connection method of the network device provided by said communication platform, the following step is further executed:
said controller sets Account IDs with access authority for said network device.

7. The method for setting the network device with the wireless area network as claim 5, wherein said controller has a built-in control application with an APP ID, and said communication platform records the APP ID of said control application, said communication platform further allows said controller and the network device to login according to the recorded APP IDs, and the controller and the network device that login to said communication platform can search and acquire the connection methods of corresponding Account ID and APP ID and can communicate and operate with each other.

8. The method for setting the network device with the wireless area network as claim 1, wherein said controller further define APP Resource in the parameter(s) for said network device, said network device has a built-in device application with an APP ID, and said communication platform records the APP ID of said network device, after said network device logs in to said communication platform and completes setting step, said communication platform records the device identification information, including login Account ID, APP ID, APP Resource and IP connection method, for said network device, as said controller has the same login Account ID/password as said network device, said controller becomes the administrator of said network device; and under the same login Account ID, a single controller can manage multiple network devices with the same APP ID but different APP Resources.

9. The method for setting the network device with the wireless area network as claim 8, wherein said controller has a built-in control application with an APP ID, and said communication platform records APP ID of said control application, said communication platform further allows said controller and the network device to login according to the recorded APP ID, and the controller and the network device that login to said communication platform to search and acquire the connection methods of corresponding APPs that can communicate and operate therewith through respective APPs.

10. A network device, to be configured as a service unit of a communication platform through a wireless network function, includes:
a wireless functional module, used to open a wireless function for announcing a WiFi SSID using an identifier as a predetermined naming method, such that an external controller can identify and access said SSID for wireless connection with said controller; and
a network connection module, used to receives parameter(s) delivered from said external controller, further to connect to said communication platform with internet link information of said parameter(s) and login to said communication platform with a login Account ID/password of said parameter(s), and become a service unit of said communication platform.

11. The network device as claim 10, further includes a management module, which sets a controller that logs in to said communication platform with the same login Account ID/password as the administrator of said network device.

12. The network device as claim 11, wherein said management module is used for the controller with administrator identity to set other Account IDs to have access authority of said network device.

13. The network device as claim 12, wherein said controller has a built-in control application with an APP ID, said network device has a built-in device application with another APP ID, and said communication platform records the APP IDs of said applications, said communication platform further allows said controller and the network device to login according the recorded APP IDs, and the controller and the network device that login to said communication platform can search and acquire the connection methods of corresponding Account ID and APP ID, and can communicate and operate therewith through respective APPs.

14. A controller, which is used to set a network device as a service unit of a communication platform through a wireless area network function, includes:
an user interface, which is used to enter a login Account ID/password to login said communication platform, as a control application having a corresponding APP ID;
a network connection module, which is used to login said communication platform with the login Account ID/password entered by said user interface, and provides the APP ID to said communication platform for said communication platform to record identification information including the login Account ID and the APP ID; and
a wireless functional module, which is used to open wireless function to search for a WiFi SSID using an device identifier as a predetermined naming method, such that after the network device that matches said SSID is found, parameter(s) entered by said user interface is delivered to said network device for said network device to connect to internet and login to said communication platform with said parameter(s) and further becomes a service unit of said communication platform.

15. The controller as claim 14, wherein said network device has a built-in device application with an APP ID, and said communication platform records the APP ID of said network device and the APP ID of said control application, said communication platform further allows said controller and the network device to login according to the recorded APP IDs, and the controller and the network device that login to said communication platform can search and acquire the connection methods of corresponding Account ID and APPID, and can communicate and operate therewith through respective APPs.

16. A communication platform for a controller to control a network device, includes:
a login module, which is used to record a login Account ID/password that allows said controller to login, after confirmed the login Account ID/password provided by said network device according to said controller is legal, said login module allows said network device to login successfully for said network device to become a service unit; and
a search module, which allows the controller to search for an IP connection method of the logged in network device by using the login Account ID and the APP ID of said network device, and provides said IP connection method that is found to said controller for said controller to connect with said network device according to said IP connection method.

17. The communication platform as claim 16, wherein if said login module confirms that an identifier of said network device, which desires to login, is legal, then said network device is allowed to login successfully, otherwise said network device is prohibited from login.

18. The communication platform as claim 16, wherein said network device has a built-in device application with an APP ID, and said login module records a APP ID of said network device, after said network device becomes a service unit, said login module records identification information, including login Account ID, APP ID and IP connection method for said network device.

19. The communication platform as claim 18, wherein said login module receives an APP Resource provided by said network device according to said controller, and after said network device becomes a service unit, said login module records identification information including login Account ID, APP ID, APP Resource and IP connection method for said network device.

20. The communication platform as claim 16, wherein, said controller has a build-in control application with an APP ID, and said login module records the APP ID of said controller, and records identification information including login Account ID and APP ID of the logged in controller.
